(19) United States
(12) Patent Application Publication
(10) Pub. No.: US 2020/0109637 A1
(43) Pub. Date: Apr. 9, 2020

(54) REDUCED STRESS IN COMPRESSOR DISC

(71) Applicant: ROLLS-ROYCE PLC, London (GB)

(72) Inventors: Pierre-Antoine J. SIS, Derby (GB); Kieran P. LUCEY, Derby (GB)

(73) Assignee: ROLLS-ROYCE PLC, London (GB)

(21) Appl. No.: 16/569,068

(22) Filed: Sep. 12, 2019

(30) Foreign Application Priority Data
Oct. 4, 2018 (GB) 1816181.0

(51) Int. Cl. F01D 5/30; F01D 5/02

(52) U.S. Cl. CPC F01D 5/30; F05D 2220/32; F01D 5/02

(57) ABSTRACT

A compressor disc includes a diaphragm portion connected to a mounting disc portion at its distal end and a cob portion at its proximal end. The cob portion having a leading edge with a shoulder section connected to an end section at Point X, and a trailing edge with a shoulder section connected to an end section at point Y, and a base. The cob portion is asymmetrical about a centreline that extends along a plane representing the geometric centre of the diaphragm portion and through to the base of the cob portion, dividing the diaphragm and cob portion into two respective cob sections, which have surface areas that differ by no more than 10%. The distance between the base of the cob portion and Point X of the leading edge may differ from the distance between the base of the cob portion and Point Y of the trailing edge.

### CROSS-REFERENCE TO RELATED APPLICATIONS

This specification is based upon and claims the benefit of priority from United Kingdom patent application number GB 1816181.0 filed on Oct. 4th 2018, the entire contents of which are incorporated herein by reference.

### BACKGROUND

### Field of the Disclosure

The disclosure relates to a mechanism for reducing the stress in a compressor cob used in a gas turbine engine.

### Description of the Related Art

Gas turbine engines incorporate a number of compressor and turbine stages, in order to compress the air prior to combustion, in the case of compressors, then to convert the exhaust gas into rotational motion in the case of turbines. In both compressors and turbines the aerofoils that interact with the air flow are secured onto individual discs. These discs or bladed discs are formed with the aerofoil being connected to the compressor mounting disc, also known as a rim. The mounting disc is in turn connected to a diaphragm that extends radially outwards from a cob at its base. The cob and the diaphragm are typically constructed of a single piece forging or casting with the width of the cob being narrowed into the diaphragm at a pair of shoulders. This connection system is the same on both the turbine discs and compressor discs. However, the cobs for compressors and turbines are quite different as the turbine cob is required to support a number of other components such as the drive arms. Consequently the shape of a turbine cob is greatly governed by the requirement to support these components, whilst at the same time allowing air to flow around them. On the other hand, compressor cobs are simpler as they do not have such requirements. Consequently, the design of these components has barely changed over time. In the prior art systems compressor cobs are designed to be symmetrical as this is considered to be the optimum way controlling the stress within these components. This stress control is important, as it plays a significant role in the lifetime of components mounted in an engine.

Despite their relatively simple design, the stress requirements of a compressor cob are quite complex as they have to be strong enough to withstand large stresses from the operating conditions within the engine. The stresses in the cob can be the result, among other issues, of thermal effects due to one side of the cob being hotter than the other, differences in airflow, or as the result of bending due to rotor level dynamics. If the stress is not properly managed it can become an issue that may limit the lifetime of the component. In the case of a bladed disc as used in a compressor a common point of failure is within the cob. Therefore, it is desirable to reduce stress in the cob and to further reduces it at other points along the diaphragm.

### SUMMARY OF THE DISCLOSURE

According to a first aspect there is provided a compressor disc comprising: a diaphragm portion connected to a mounting disc portion at its distal end and a cob portion at its proximal end;

the cob portion having a leading edge comprising a shoulder section connected to an end section at Point X, and a trailing edge comprising a shoulder section connected to an end section at point Y, and a base;
wherein the cob portion is asymmetrical about a centreline that extends along a plane representing the geometric centre of the diaphragm portion and through to the base of the cob portion, dividing the diaphragm and cob portion into two respective cob sections, and
wherein the cob sections of the cob portion have volumes that differ by no more than 20% from each other.

The modification of the shape of the cob in this way has been found to produce the desirable effect of moving the stress closer to the centreline. Also, changing the volumes of the cob to be different has been found to reduce the stress. Moving the stress away from the edge and to the centre of the component as well as lowering it will have the beneficial effect of reducing the risk of failure in the component, which can result in the engine being kept on the wing longer.

The cob sections of the cob portion may have volumes that differ by no more than 10% from each other.

The distance between the base of the cob portion and Point X of the leading edge may be different to the distance between the base of the cob portion and Point Y of the trailing edge.

The distance between the base of the cob portion and Point Y of the trailing edge may be greater than the distance between the base of the cob portion and Point X of the leading edge.

The shoulder section of the trailing edge of the cob portion may have the same radius of curvature as the shoulder section of the leading edge of the cob portion.

The shoulder section of the leading edge of the cob portion may have a radius of curvature that is different to that of the shoulder section of the trailing edge of the cob portion.

The base of the cob portion may have a chamfered corner between the base of the cob portion and one of the end sections.

An aperture may be located adjacent to the distal end of the diaphragm through which to receive a fastener to secure the diaphragm portion of the compressor disc to the mounting disc portion of the compressor disc.

The compressor disc may be used in a gas turbine engine.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### BRIEF DESCRIPTION OF THE DRAWINGS

Embodiments will now be described by way of example only, with reference to the Figures, in which:

FIG. 1 is a sectional side view of a gas turbine engine;

FIG. 2 is an example of a prior art compressor disc;

FIGS. 3a-c shows the stress modelling results for different cob configurations: FIG. 3a shows an example of a prior art symmetric cob; FIG. 3b shows a cob in which extra mass has been positioned at the front of the cob; and FIG. 3c shows a cob in which has been completely reshaped (These figures are shown with their respective stress levels shown);

FIG. 4 shows the profile of an asymmetric cob of the present disclosure broken down the centreline into a pair of respective sections;

FIG. 5a shows the effect of varying the surface areas of the halves shown in FIG. 4 in relation to the peak cob stress, whilst FIG. 5b shows the same plot, but for the peak surface stress;

FIG. 6 shows a comparison in the profiles between a prior art symmetrical cob and an asymmetrical cob of a compressor disc of the present disclosure.

### DETAILED DESCRIPTION OF THE DISCLOSURE

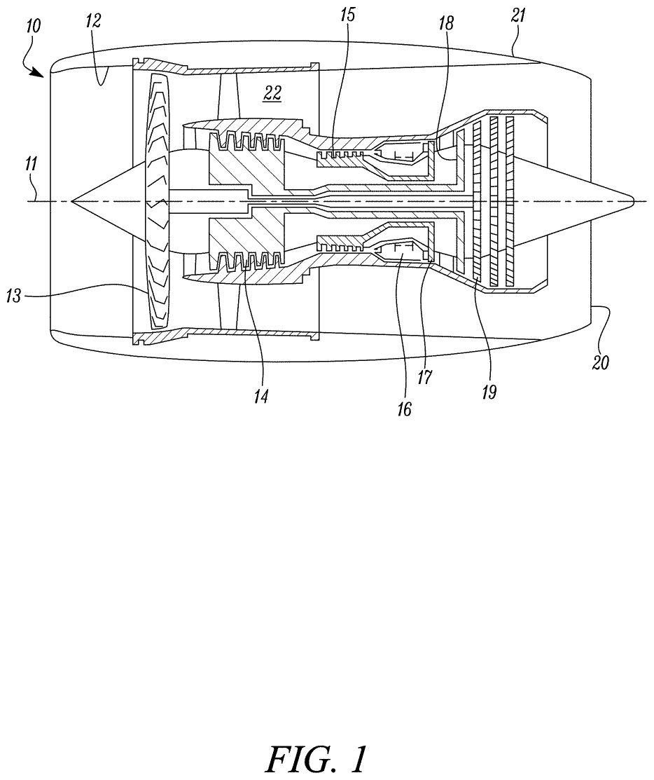

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

The present disclosure may relate to a gas turbine engine. Such a gas turbine engine may comprise an engine core comprising a turbine, a combustor, a compressor, and a core shaft connecting the turbine to the compressor. Such a gas turbine engine may comprise a fan (having fan blades) located upstream of the engine core.

Arrangements of the present disclosure may be particularly, although not exclusively, beneficial for fans that are driven via a gearbox. Accordingly, the gas turbine engine may comprise a gearbox that receives an input from the core shaft and outputs drive to the fan so as to drive the fan at a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and compressor rotate at the same speed (with the fan rotating at a lower speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) flow from the first compressor.

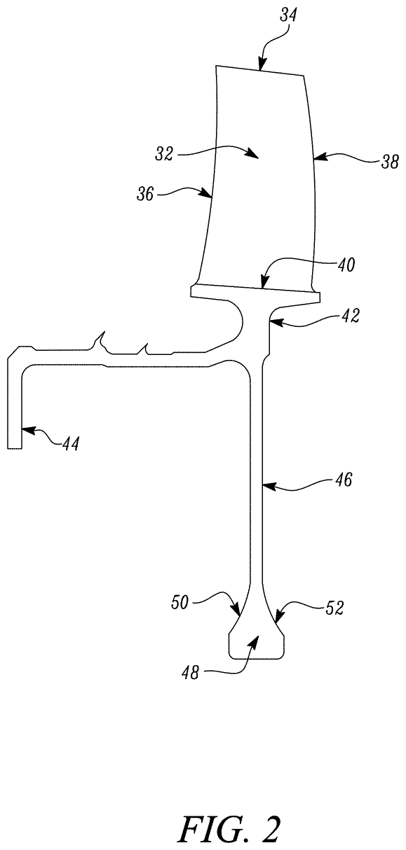

FIG. 2 presents a prior art example of a compressor disc 30. In this the aerofoil 32 has a tip 34 and leading and trailing edges 36 and 38 respectively. It is the rotation of these aerofoils about a central drive shaft that accelerates the air to force it onto an adjacent row of stator vanes, where the air is decelerated. This change in kinetic energy of the air from the rotating compressor blades to the stator translates into a pressure rise in the air. The compressor blades are connected to the compressor disc at a neck. This neck portion forms part of the mounting disc to which the front flange 44 is connected. In order to connect the mounting disc to the drive shaft a cob 48 is used, which is connected to the mounting disc via an intermediate diaphragm. The cob extends outwardly from the diaphragm from a pair of curved shoulders 50 and 52 on the leading and trailing edges, each having a radius of curvature.

In studying the stress profiles within the cob it has been found advantageous for the area of peak stress to be moved as close to the centreline as possible. In this the centreline is classed as a line that extends along a plane which runs through the length of the diaphragm at its geometrical centre and into the cob. To move this stress area extra mass can be added to portions of the cob that are close to the area of peak stress; for example this can have the effect of moving the peak stress away from an edge. By moving the stress away from the edge and towards the centre of the component will have the beneficial effect of reducing the risk of failure in the component. Furthermore, by adding the extra material to an area that is more likely to fail will also strengthen the component. However, in carrying out the process of adding material to areas of high stress it will also cause the mass of the component to increase, which also increases the mass of the engine.

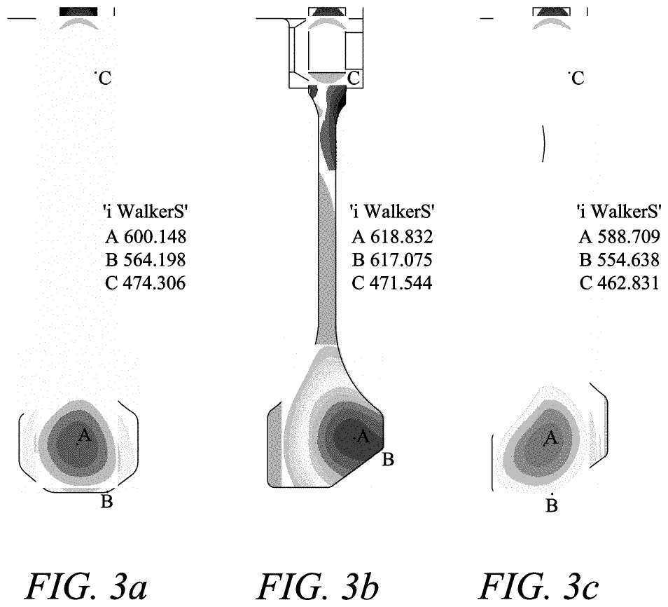

In order to overcome the conflicting issues, of increased mass, but better stress management it has been found that redistributing the mass in an asymmetric way can bring about the desired effect. In situations where the stress distribution is symmetric shaping of the cob may localise and/or reduce the stress within it. The results of modelling the stress distribution in various designs for the cob of a compressor disc are presented in FIGS. 3a-c. The modelling of the stress is a simulation of the walker stress of within the component. FIG. 3a shows a typical symmetric cob, wherein the location of the point of highest stress—point (A)—is in the centre of the cob, and the location of the point of peak surface stress—point (B)—is located at a corner on the trailing edge of the cob. In this document the relative terms, forwards, rear, leading and trailing are described relative to the orientation of the engine. FIG. 3b shows the effect of incorrectly redistributing the mass in the system, in this mass was added to the leading edge corner and the trailing edge chamfer/bevel has been increased to try and move the point of peak surface stress closer to the centreline. This however, has had the effect of moving the peak cob stress (A) away from the centreline towards the trailing edge of the cob and the peak surface stress (B) has also moved closer to the point of peak stress. This configuration is undesirable as having the point of peak stress located close to the point of peak surface stress can result in a greater chance of failure of the component. Furthermore, due to this redistribution of mass the peak stress values in both cases have increased, along with an increase in the stress at the point where the diaphragm is connected to the mounting disc. FIG. 3c shows a complete reshaping of the cob, which has resulted in a reduction in the stress values. In this example mass has been added to the trailing edge, as this was the side that was closest to the peak stress in the systems of both FIGS. 3a and 3b. In order for the mass of the cob not to increase due to the increase in height of the trailing edge shoulder section, the leading edge shoulder section height has been reduced to compensate for this redistribution of mass. Balancing the mass in this way means that the cob can therefore have a substantially similar mass to that of the symmetric prior art example shown in FIG. 3a. The benefits to this shape change to the cob can be seen from FIG. 3c. In this it is shown that the location of peak stress (A) and also the peak surface stress (B) has moved closer to the centreline, when compared with the situation in FIG. 3a. Furthermore, in modifying the shape in this way, there has been an overall decrease in the calculated values for both the peak stress and the peak surface stress. Additionally, a lowering of the bolt hole stress can be noticed at point C, which is in part due to the lowering of the cob portion within the engine.

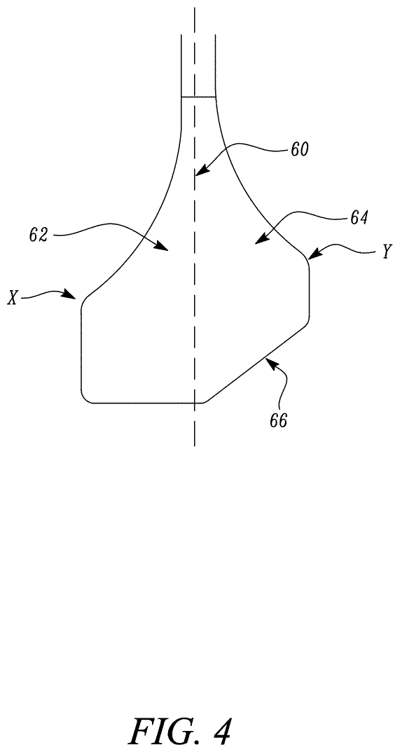

FIG. 4 shows a schematic of the asymmetric cob broken down into its respective sections 62, 64, which are separated by a centreline 60. On both sides, the cob portion has a shoulder section connected to an edge portion at points X and Y for the leading and trailing edge portions respectively. Section 62 represents the volume of the leading edge of the cob section, whilst section 64 represents the volume of the cob section on the trailing edge. If this concept is applied to the designs shown in FIG. 3a, then in the symmetric cob volume of sections 62 and 64 are equal to each other. If applied to the design in FIG. 3b then volume of section 62 is greater than the volume of section 64, whilst for FIG. 3c the volumes 62 and 64 are approximately equal. The figure also shows a chamfer 66 applied to one of the corners between the base and an edge portion, in this case the trailing edge portion. The chamfer may be also allow for the component to fit around other components of the engine. This change in the geometry of the cob can then also be positioned lower, that is to say closer to the centre of the engine, relative to a prior art example.

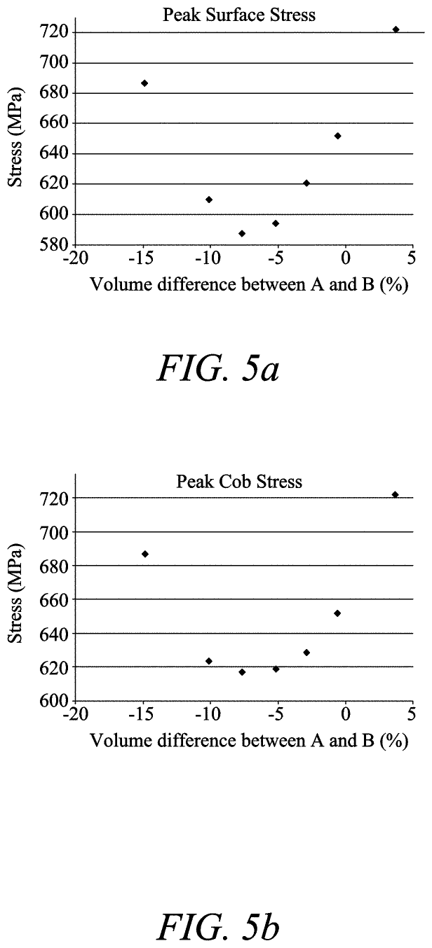

The relationship between the different surface areas of the sections in the asymmetric cob of the present disclosure is shown in FIGS. 5a and 5b. In both graphs, which relate to the peak surface stress and peak cob stress respectively it can be seen that surprisingly there is a reduction in the stress if the two surface areas are not equal. In this the reduction is seen in situations where the surface area of cob section 64 is greater than that of cob section 62. The optimal value for this stress reduction has been found if the surface areas of the two cob sections are kept within 5% of each other, but with the area of cob section 64 being larger than that of 62. For the design configuration shown, the best results were achieved with cob section 64 being 1-2% larger than that of cob section 62. If however, the peak surface stress was located on the leading edge, rather than the trailing edge, a similar, but opposite, redistribution of mass can be applied to move the stress back in the cob towards the centreline. In the cob design shown in FIG. 3c the radius of curvature of the two shoulders sections (shown as 50 and 52 in FIG. 2) is shown to be equal, however, it is possible that the shoulders of the cob can have different radii. Observations for devices conforming to these design criteria show that not only is there lower peak stress in the cob, But there is also, a localisation of the stress in the component, which results in a reduced volume of higher stressed materials.

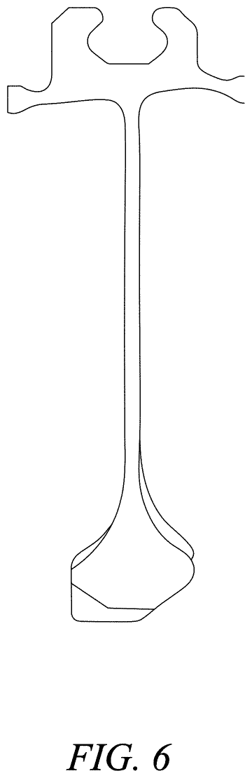

FIG. 6 shows a comparison between a conventional cob and the redesigned cob shown in FIG. 3c. As can be seen from this figure, the effect of changing the shape can also have the desirable effect of lowering the radial position of the cob; this in turn reduces the stress in the aperture of the diaphragm. This will also result in an increased stability of the object, which will also help to reduce effects of aeroelasticity and rim-rolling.

It will be understood that the disclosure is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

We claim:

1. A compressor disc comprising: a diaphragm portion connected to a mounting disc portion at its distal end and a cob portion at its proximal end;
the cob portion having a leading edge comprising a shoulder section connected to an end section at Point X, and a trailing edge comprising a shoulder section connected to an end section at point Y, and a base;
wherein the cob portion is asymmetrical about a centreline that extends along a plane representing the geometric centre of the diaphragm portion and through to the base of the cob portion, dividing the diaphragm and cob portion into two respective cob sections, and
wherein the cob sections of the cob portion have volumes that differ by no more than 20% from each other.

2. The compressor disc as claimed in claim 1, wherein the cob sections of the cob portion have volumes that differ by no more than 10% from each other.

3. The compressor disc as claimed in claim 1, wherein the distance between the base of the cob portion and Point X of the leading edge is different to the distance between the base of the cob portion and Point Y of the trailing edge.

4. The compressor disc as claimed in claim 3, wherein the distance between the base of the cob portion and Point Y of the trailing edge is greater than the distance between the base of the cob portion and Point X of the leading edge.

5. The compressor disc as claimed in claim 1, wherein the shoulder section of the trailing edge of the cob portion has the same radius of curvature as the shoulder section of the leading edge of the cob portion.

6. The compressor disc as claimed in claim 1, wherein the shoulder section of the leading edge of the cob portion has a radius of curvature that is different to that of the shoulder section of the trailing edge of the cob portion.

7. The compressor disc as claimed in claim 1, wherein the base of the cob portion has a chamfered corner between the base of the cob portion and one of the end sections.

8. The compressor disc as claimed in claim 1, wherein an aperture is located adjacent to the distal end of the diaphragm through which to receive a fastener to secure the diaphragm portion of the compressor disc to the mounting disc portion of the compressor disc.

9. A gas turbine engine comprising at least one compressor disc as claimed in claim 1.
